(19) United States
(12) Patent Application Publication
(10) Pub. No.: US 2017/0098185 A1
(43) Pub. Date: Apr. 6, 2017

(54) Apparatus and Method for Aggregating Like Products for Customer Product Orders

(71) Applicant: Wal-Mart Stores, Inc., Bentonville, AR (US)

(72) Inventors: David W. Soldate, Sammamish, WA (US); John Luna, Pea Ridge, AR (US)

(21) Appl. No.: 15/315,056

(22) PCT Filed: May 29, 2015
(86) PCT No.: PCT/US15/33142

§ 371 Date: Nov. 30, 2016

Related U.S. Application Data
(60) Provisional application No. 62/005,833, filed on May 30, 2014.

(51) Int. Cl. G06Q 10/08; G06Q 30/06

(52) U.S. Cl. CPC G06Q 10/083; G06Q 30/0633

(57) ABSTRACT

A memory has stored therein information for an enterprise. This information can include product inventory information for a plurality of differing products at each of a plurality of enterprise nodes along with delivery-chain specifications regarding a plurality of different order-fulfillment delivery chains. A control circuit that operably couples to that memory serves to automatically aggregate like products for product orders entered by a plurality of different customers (such as, but not limited to, on-line customers) as a function of the product inventory information and the delivery-chain specifications to reduce delivery costs.

### RELATED APPLICATION(S)

This application claims the benefit of U.S. Provisional Application No. 62/005,833, filed May 30, 2014, which is incorporated by reference in its entirety herein.

### TECHNICAL FIELD

These teachings relate generally to order-fulfillment systems.

### BACKGROUND

Many enterprises accept product orders from a variety of customers including on-line customers. It is known to aggregate at a distribution center the various items ordered by a single such customer into a single shipment to be delivered directly to the customer. It is also known in the art to offer customers a choice between receiving delivery of their product orders directly at their home address (or other customer address, such as a workplace address) or at a retail facility for the enterprise. The latter approach is often referred to as an in-store pickup. And it is also known in the art to choose from amongst a plurality of different delivery chains by which a customer's product orders can be facilitated.

Unfortunately, the logistic possibilities posed by some enterprises with respect to such options can and do become sufficiently complex as to effectively stymie the reliable selection of least-cost options for delivering ordered products in a way that assures meeting the expectations of the corresponding customers. These difficulties, in turn, can lead to overall increased costs of operation that are typically ultimately borne by the customers themselves.

### BRIEF DESCRIPTION OF THE DRAWINGS

The above needs are at least partially met through provision of the apparatus and method for aggregating like products for customer product orders described in the following detailed description, particularly when studied in conjunction with the drawings, Wherein:

FIG. 1 comprises a flow diagram as configured in accordance with various embodiments of these teachings;

FIG. 2 comprises a block diagram as configured in accordance with various embodiments of these teachings;

FIG. 3 comprises a schematic representation as configured in accordance with various embodiments of these teachings;

FIG. 4 comprises a schematic representation as configured in accordance with various embodiments of these teachings;

FIG. 5 comprises a schematic representation as configured in accordance with various embodiments of these teachings; and

FIG. 6 comprises a schematic representation as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art wilt understand that such specificity with respect to sequence is not actually required. The terms and expressions used herein have the ordinary technical meaning as is accorded to such terms and expressions by persons skilled in the technical field as set forth above except where different specific meanings have otherwise been set firth herein.

### DETAILED DESCRIPTION

Generally speaking, these teachings provide a memory having stored therein information for an enterprise. This information can include product inventory information for a plurality of differing products at each of a plurality of enterprise nodes along with delivery-chain specifications regarding a plurality of different order-fulfillment delivery chains. A control circuit that operably couples to that memory serves to automatically aggregate like products for product orders entered by a plurality of different customers (such as, but not limited to, on-line customers) as a function of the product inventory information and the delivery-chain specifications to reduce delivery costs.

By one approach those enterprise nodes include one or more distribution centers and/or retail facilities that may or may not be geographically distributed with respect to one another. The order-fulfillment delivery chains, in turn, may include delivery chains that provide fir delivering an ordered product to a customer's address as well as delivery chains that provide for delivering an ordered product to an enterprise's retail facility for in-store pickup by the customer.

By one approach the control circuit aggregates the like products, at least in part, by automatically considering opportunities to cartonize a plurality of like products as ordered by different customers. These teachings will also readily accommodate aggregating like products by taking into account delivery due dates as correspond to one or more of the product orders.

So configured, these teachings achieve least-cost (or at least reduced-cost) order-fulfillment performance notwithstanding a large number of relevant variables for a given enterprise (regarding, for example, the number and location of distribution centers and/or retail facilities, the respective individual processing capacity of at least some and perhaps all of these nodes, as well as greatly varying delivery Chains). Achieved savings, in turn, can be passed along at least in part to the benefit of the customers by way of reduced product pricing and/or reduced delivery costs.

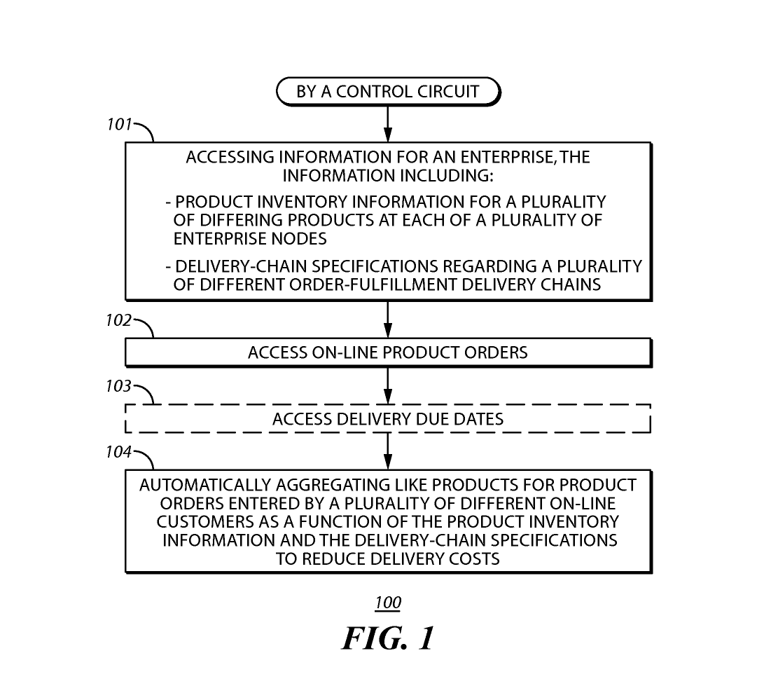

These and other benefits may become clearer upon making a thorough review and study of the following detailed description. Referring now to the drawings, and in particular to FIG. 1, an illustrative process 100 that is compatible with many of these teachings will now be presented.

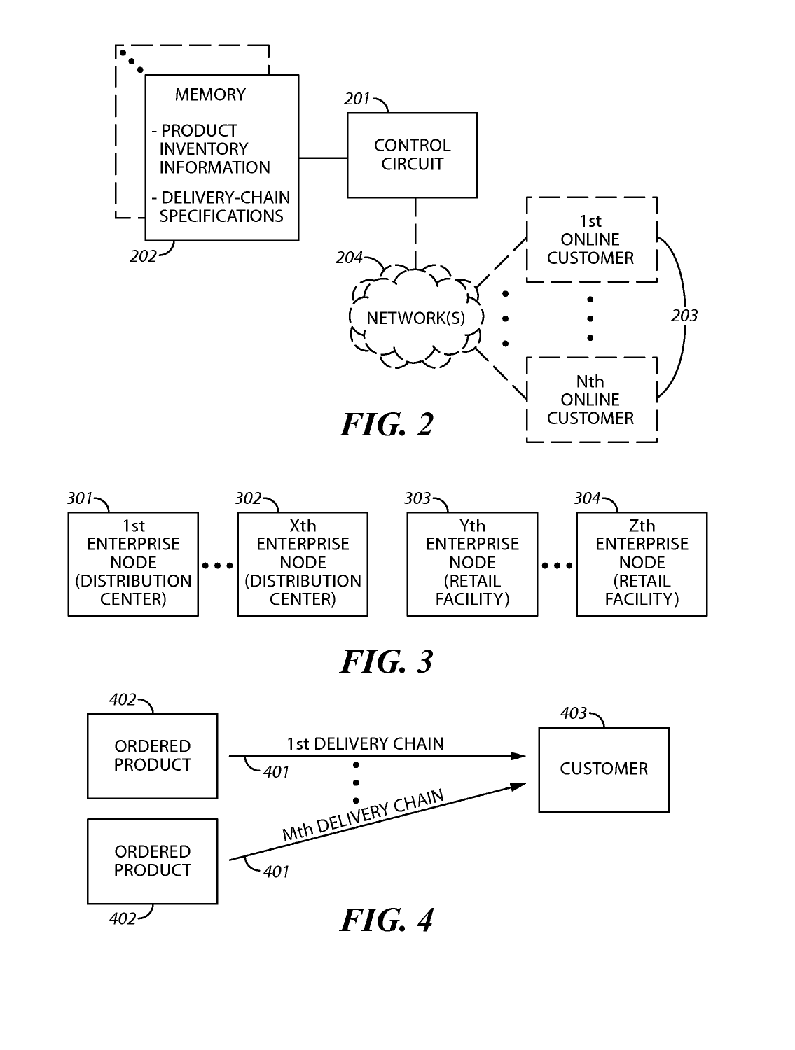

In the illustrative examples described herein it will be presumed that a control circuit of choice carries out the described actions of this process 100. Referring momentarily to FIG. 2, this control circuit 201 can comprise a fixed-purpose hard-wired platform or can comprise a partially or wholly programmable platform. By one approach this control circuit 201 comprises a massive parallel processing (MPP) platform and/or a platform that effects thread-based design techniques as these approaches can readily handle the expected computational volumes in a timely manner. These architectural options are well known and understood in the art and require no further description here. This control circuit 201 is configured (for example, by using corresponding programming as will be well understood by those skilled in the art) to early out one or more of the steps, actions, and/or functions described herein.

In this illustrative example the control circuit 201 operably couples to a memory 202. The memory 202 may be integral to the control circuit 201 or can be physically discrete (in whole or in part) from the control circuit 201 as desired. This memory 202 can also be local with respect to the control circuit 201 (where, fur example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201). It will also be understood that as used herein the expression “memory” can refer to a single physically and logically discrete component or can refer to a plurality of such components that together constitute a memory.

This memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

This memory 202 also serves to store product inventory information for a plurality of differing products at each of a plurality of enterprise nodes for a given enterprise (such as, for example, a major retailer). By way of illustration and without intending any particular limitations in these regards, these enterprise nodes are facilities within one or more supply chains that manufacture, distribute (other than directly to a customer), and/or sell retail products directly to end-user customers.

As shown in FIG. 3, for a given enterprise these enterprise nodes might include a first through an Xth enterprise node (301 and 302) that comprise distribution centers and a Yth through a Zth enterprise node (303 and 304) that comprise retail facilities. As used herein, the expression distribution center refers to a facility that receives products (either as manufactured, in whole or in part, on site or as received from a geographically remote manufacturer) and that further distributes such products to a retail facility or via shipping directly to customers. By way of contrast the expression retail facility refers to a physical establishment, such as a so-called bricks-and-mortar store, where a customer can physically visit, make a product selection from a corresponding display of products, purchase the selected product, and typically take immediate possession of the purchased product.

Accordingly, the aforementioned product inventory information constitutes information regarding what distributable products are physically located at each such enterprise node at a given point in time, and how many such products are so located.

By one approach this memory 202 also stores information regarding traffic capacity for some or all of these enterprise nodes. This information regarding traffic capacity can represent, for example, how many items a particular enterprise node can actually process in terms of selection, handling, packing, and so forth during some time period of interest (such as an hour, or a work shift, or per day, and so forth). This information regarding traffic capacity can reflect historical information for such nodes and/or a presently-calculated metric regarding at least near real-time performance for these nodes.

This memory 202 can also include information comprising delivery-chain specifications regarding a plurality of different order-fulfillment delivery chains as correspond to the enterprise. As illustrated in FIG. 4, by one approach these delivery chains can include delivery chains 401 that provide for delivering an ordered product 402 to a customer's address 403. These different delivery chains 401 can pertain to a same product as might be found at a particular point of origin or to different like products that are found at different points of origin.

It should be understood that these illustrative delivery chains 401 are schematic in nature and do not necessarily imply a lack of stops or changes in transport modality along the length of any particular delivery chain. Instead, these teachings will readily accommodate a delivery chain that itself comprises, for example, a variety of transport modalities. For example, a single delivery chain from point of origin for a given ordered product to the point of delivery per the customer's directive can include one segment during which the ordered product moves by an enterprise-owned tractor-trailer rig, another segment during which the ordered product moves by a local delivery van, and yet another segment during which the ordered product moves via the United States Postal Service. Generally speaking, a typical delivery chain comprises any number of sending nodes and receiving nodes that, when chained together, form a resultant end-to-end delivery chain.

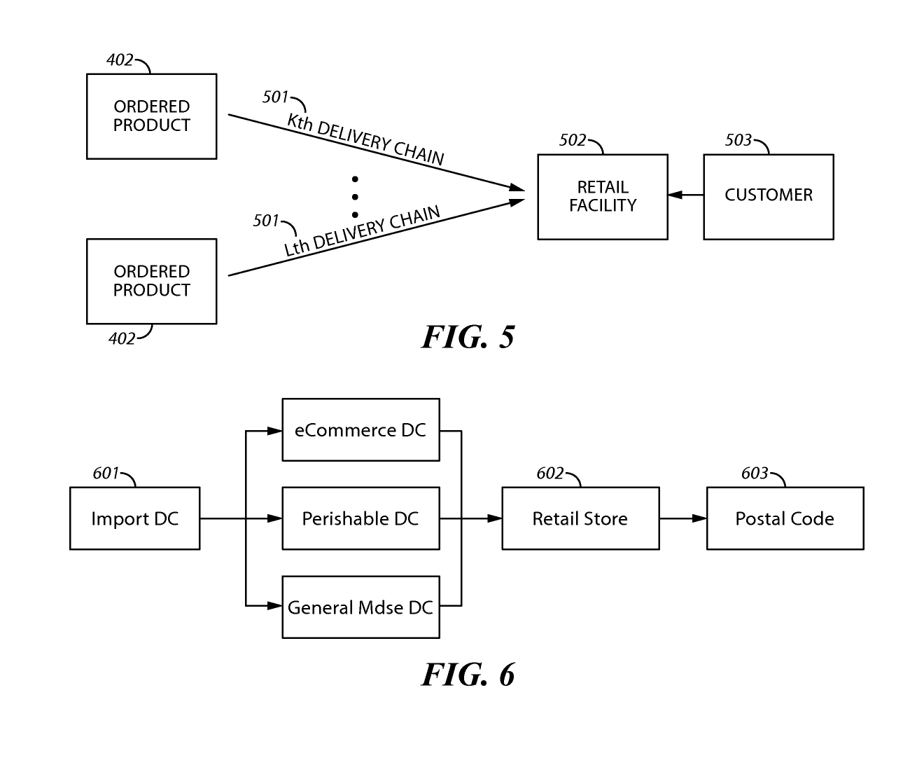

As illustrated in FIG. 5, these teachings will also accommodate delivery chains 501 that provide for delivering an ordered product 402 to an enterprise retail facility 502 for in-store pickup by a customer 503. As with the delivery chains 401 discussed above in FIG. 4, these delivery Chains 501 can similarly comprise a variety of differing transport/service modalities.

These delivery chains can include chains that rely fully or at least in substantial part upon a use of enterprise-controlled vehicles (including, for example, enterprise-owned and/or enterprise-leased/contracted tractor-trailer rigs, trailers, trucks, vans, cars and other wheeled terrestrial vehicles as well as any of a variety of aircraft or watercraft). By one approach, the aforementioned reference to “substantial” can refer to, say, at least fifty percent of the distance from the product's point of origin at the time of the order being taken to the designated point of customer delivery (i.e., the customer address or the particular retail facility where the customer wishes to pick up the product).

By another approach, one or more of these delivery chains can include chains that rely fully or at least in substantial part upon a use of third-party-controlled vehicles (such as but not limited to vehicles controlled by the United States Postal Service, the United Parcel Service, the FedEx service, and so forth). Accordingly it will be understood that these teachings are highly flexible in these regards and will accommodate a wide variety of delivery chain configurations and paradigms.

FIG. 6 provides an illustrative example in these regards. In this example there are three delivery chains that each include four segments. All three delivery chains share three of those segments (a first segment comprising an import distribution center 601, a third segment comprising a retail store 602, and a fourth segment comprising a postal code 603). Each segment represents a defined method for transporting goods between a sending node and a receiving node. This defined method can include, for example, the mode of transportation, a corresponding transportation cost, and expected lead or delivery times.

By one approach, each node in such a delivery chain is configured in terms of what type or types of fulfillment can be supported. For example, a retail store may be configured as only supporting an individual picking operation (where individual products are picked). An e-commerce distribution center, on the other hand, may be able to support shipping both for cases (i.e., groups of products) as well as individual picking.

These teachings will accommodate the prioritization of services within a given delivery chain. For example, while both a retail store and a general merchandise distribution center can provide a full case fulfillment service, the general merchandise distribution center may be a preferred enterprise knows when processing fulfillment orders over the retail store.

If desired, the information regarding the delivery chains can also include information regarding not only the carrier and/or mode of transportation but, for example, a corresponding grade of service. By way of illustration, one delivery chain might include parcel post service by the United States Postal Service, another delivery chain might include Priority mail service by that same service provider, and yet another delivery chain might include Express mail service by that same service provider, all of which might typically represent the use of vehicles owned or operated by the United States Postal Service but which typically have differing corresponding en-route time frames.

Referring again to FIG. 2, in this illustrative example on-line customers 203 enter orders for particular products from the enterprise via one or more intervening networks 204. Various communications networks are known in the art, including the ubiquitous Internet. Accordingly, no further elaboration in these regards will be provided here. By one approach the aforementioned control circuit 201 actively participates in the product ordering activity. By another approach the control circuit 201 accesses product order information as facilitated by one or more other platforms of choice (not shown). Again, activities in these regards constitute a well-known area of prior art endeavor that requires no further description here.

Referring again to FIG. 1, at block 101 the aforementioned control circuit 201 accesses the aforementioned information for the relevant enterprise. In particular, this includes product inventory information for a plurality of differing products at each of a plurality of enterprise nodes as well as delivery-chain specifications regarding a plurality of different order-fulfillment delivery chains, all as discussed above. These teachings will also accommodate considering traffic/processing capacity limits at these nodes (including both enterprise nodes and delivery chains if desired.

At block 102 the control circuit 201 accesses the aforementioned on-line orders. By one approach the control circuit 201 may only access such information from time to time on an aperiodic or periodic basis as desired. For example, the control circuit 201 may only access such information once every 30 minutes, every hour, every three hours, every six hours, every day, or such other period of time as may best suit the needs of a particular application setting.

For many application settings it will also be beneficial for the control circuit 201 to access delivery date preferences or requirements as correspond to the product orders. Accordingly, this process 100 can optionally include block 103 to accommodate such activity. This delivery date information may represent a particular customer's requirements and/or a representation or policy of the enterprise as desired.

At block 104 the control circuit 201 automatically aggregates like products for product orders entered by a plurality of different on-line customers as a function of the product inventory information and the delivery-chain specifications (and also node/chain capacity-limits information if desired). More particularly, the control circuit 201 carries out this aggregation to reduce delivery costs as correspond to those orders such that those delivery costs are preferably minimized. By one approach, the control circuit 201 calculates the costs to serve for each potential aggregation permutation to thereby derive a resultant decision.

By one approach this aggregation includes automatically considering opportunities to cartonize a plurality of like products as ordered by different customers. As used herein, the expression cartonize will be understood to refer to placing a plurality of products into a shared container such as a corrugated cardboard box or the like. By another approach the shared container can comprise shrink wrap material or a thin plastic clinging film that surrounds and encapsulates the plurality of products to thereby form a single transportable object (sometimes supported by or otherwise inclusive of a pallet).

As a simple illustrative example, 10 on-line customers in the same town may order the same product, with six of the customers opting for in-store pickup and the remaining four customers choosing home delivery. In this example a single distribution center for this enterprise has that quantity of this product in stock. All things considered, the control circuit 201 may provide for ten of those products to be placed in a shared container (i.e., canonized) and shipped via an enterprise-owned/controlled vehicle to the retail facility for the town in question. Upon delivery of that container to that retail facility, six of those products can be removed from the container and held for in-store pickup by the corresponding customers while the remaining four products are individually mailed via a local mail service to the customers who requested at-home delivery.

As noted above, the control circuit 201 may have access to delivery due dates as correspond to at least some of the product orders. In that case the aforementioned aggregation can further take into account that delivery due date information. If a particular candidate aggregation opportunity would cause at least one of the aggregated products to be delivered later than required, per this approach the control circuit 201 might reject that candidate aggregation opportunity.

Those skilled in the art will recognize and understand that these teachings can be leveraged in a variety of ways. As but one example in these regards, these teachings will accommodate capturing the grouping and aggregation of line item quantities for customer orders by delivery date. These teachings will also accommodate employing the anticipated. capacity or utilization of a particular enterprise node as a constraint in the aggregation decision process. By accounting for not only available inventory but information regarding delivery times as well, these teachings facilitate avoiding the use of an enterprise node that may have available inventory to satisfy a number of existing orders but which cannot reliably deliver the ordered product by when the customer needs that product.

These teachings will also accommodate calculating, for each enterprise node, an amount of a particular candidate aggregated order that can be filled in a pack configuration that is optimized for that particular enterprise node. By one approach that calculation can determine a remaining residual quantity. If desired, these teachings will accommodate resolving the residual by either rounding the residual into a quantity that the enterprise node can pick or by sending the residual to another enterprise node to pick.

By way of further elaboration in these regards, and to illustrate the flexibility of these teachings, specific examples regarding certain aspects of the foregoing will now be presented. It should be understood that these examples are intended to serve an illustrative purpose and are not intended to suggest any particular limitations with respect to the scope of these teachings.

As customer orders are received, regardless of the retail channel used to take the order, they can be collected into a customer order pool. The orders can be extracted from the customer order pool, aggregated, and then restructured into a new format. The orders can be grouped by their deliveryDays and finalDestinationId and marked with a unit orderBatchId. This approach can ease downstream consolidation processes back into the original orders. The structure set forth in Table 1 demonstrates such an approach.

TABLE 1

| | | | | | |
|---|---|---|---|---|---|
| orderBatchId | deliveryDays | finalDestinationID | destinationLocationID | itemNumber | orderedUnitQty |

```
Where:
  orderBatchID is the unique identifier that will allow these items to be
associated back to the batch of customer orders that will be filled,
  finalDestination is the actual destination where the order will be delivered.
This allows for a store to be used as the destination ID but the store may do home delivery
from that point.
  destinationLocationID is the retail store that will either be where the customer
will pick up the order or the store that will deliver the order within the postal area.
  deliveryDays are the days remaining until the item must be delivered.
  itemNumber is the unique identifier for the product being ordered by the
customer,
  orderedUnitQuantity is the aggregated number of units ordered by the
customers.
```

Leveraging the network information, additional information can be appended to the order structure that reflect which nodes in the network could be leveraged to service the quantity. To be included in this list, it may be required that the node must be within a delivery chain that will service the destinationLocationID, has inventory for the item, and has a lead time that meets or exceeds the service level. The structure set forth in Table 2 demonstrates such an approach.

TABLE 2

| | | | | | |
|---|---|---|---|---|---|
| orderBatchId | deliveryDays | finalDestinationID | destinationLocationID | itemNumber | orderedUnitQty |
| | servicingNode | servicePriority | availableInventory | leadTime | |

When calculating available inventory within the node, not only the current on hand can be leveraged but also inbound merchandise that is due to be delivered. The structure set forth in Table 3 represents the information that can be leveraged to determine if a node has available inventory to fill an order.

TABLE 3

| | | | |
|---|---|---|---|
| servicingNode | currentOnHand | committedInventory | inboundInventory |

```
Where:
  currentOnHand is the amount of inventory that is within the building
  committedInventory is the amount of inventory that has orders pending to be
processed.
  inboundInventory is the amount of inventory that is expected to be delivered and can
be based upon inbound purchase or stock transfer orders and the expected delivery or must
arrive by dates.
```

With this information and based upon the services provided by the node, it can be calculated how many full, inner, and residual picks will be needed to fill the order. The information can be grouped by deliveryDays, destinationLocationId, servicingNode, and the itemNumber and will aggregate the orderedUnitQty. For each servicing node, the number of full and inner cases can be calculated as well as any residual units based upon the services provided by the servicing node as well as the available inventory within the node. The structure shown in Table 4 represents the corresponding outcome.

TABLE 4

| | | | | | |
|---|---|---|---|---|---|
| deliveryDays | destinationLocationId | servicingNode | itemNumber | orderedUnitQty | availableInventory |
| | nbrFullCasesFilled | nbrInnerCasesFilled | nbrResidualUnits | | |

By one approach, the foregoing structure can employ the following calculations:
nbrUnitsOrderedModified=if(availableinventory<nbrUnitsOrdered,availableInvenotry,nbrUnitsOrdered)
nbrFullCasesFulfilled=integer(nbrUnitsOrderedModified/vendorPackEach)
nbrInnerCasesFulfilled=integer(nbrUnitsOrderedModified/innerPackEach)−(nbrVendorCasesFulfilled*vendorPackEach)
residualUnitsFulfilled=nbrUnitsOrdered−(nbrVendorCasesFulfilled*vendorPackEach)−(nbrInnerPacksFulfilled*innerPackEach)
   where:
vendorPackEach are the number of eachs or units within a full vendor case; and
innerPackEach are the number of caches or units within an inner pack.

If desired, these teachings will also accommodate a final calculation to calculate the total cost to serve for each delivery chain that provides service to the destinationID and that can meet the deliveryDays leveraging the information. This should leverage each node in the delivery chain and calculate service costs to fulfill and move the merchandise to the finalDestinationID leveraging the service priority to make determinations on which nodes are preferred for full, inner case fulfillment as well as performing the residual unit pick fulfillment.

Service costs typically include handling and transportation costs that can vary by item characteristics and pack fulfillment. Transportation costs can either be included as part of the handling costs or can leverage light weight cartonization logic that will estimate the number of outbound cases. The former provides a less-complicated algorithm Whereas the second may provide a more accurate estimate if leveraging small pack or less-than-truckload carriers.

The final structure could leverage the information shown in Table 5:

TABLE 5

| | | | | | |
|---|---|---|---|---|---|
| networkID | servicingNode | deliveryDays | nbrFullCaseFilled | nbrInnerCaseFilled | nbrUnitsFilled |
| | estHandlingCosts | estTransportationCosts | totalCostToServe | | |

So configured, these teachings permit a large and logistically complex enterprise to leverage its potential aggregation opportunities in favor of reduced costs rather than being the economic victim of such complexity. By proactively considering and selecting the aggregation of product orders for various customers, including on-line customers, these teachings can achieve substantial cost reductions without unduly negatively impacting delivery time requirements as well.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a memory having stored therein information for an enterprise, the information including:
product inventory information for a plurality of differing products at each of a plurality of enterprise nodes;
delivery-chain specifications regarding a plurality of different order-fulfillment delivery chains;
a control circuit operably coupled to the memory and configured to:
automatically aggregate like products for product orders entered by a plurality of different customers as a function of the product inventory information and the delivery-chain specifications to reduce delivery costs.

2. The apparatus of claim 1 wherein the plurality of enterprise nodes includes at least one distribution center and at least one retail facility.

3. The apparatus of claim 2 wherein the plurality of enterprise nodes includes a plurality of geographically distributed distribution centers and a plurality of geographically distributed retail facilities.

4. The apparatus of claim 3 wherein the plurality of different order-fulfillment delivery chains includes order-fulfillment delivery chains that provide for delivering an ordered product to a customer's address as well as order-fulfillment delivery chains that provide for delivering an ordered product to an enterprise retail facility for in-store pickup by a customer.

5. The apparatus of claim 3 wherein the plurality of different order-fulfillment delivery chains includes order-fulfillment delivery chains that rely at least in substantial part upon a use of enterprise-controlled vehicles.

6. The apparatus of claim 5 wherein the plurality of different order-fulfillment delivery chains further includes order-fulfillment delivery chains that rely at least in substantial part upon use of third-party-controlled vehicles.

7. The apparatus of claim 1 wherein the control circuit is configured to automatically aggregate like products for product orders entered by a plurality of different customers as a function of the product inventory information and the delivery-chain specifications by, at least in part, automatically considering opportunities to cartonize a plurality of like products as ordered by different customers.

8. The apparatus of claim 1 wherein the control circuit is configured to automatically aggregate like products for product orders entered by a plurality of different on-line customers as a function of the product inventory information and the delivery-chain specifications by, at least in part, taking into account delivery due dates as correspond to at least some of the product orders.

9. A method comprising:
by a control circuit:
accessing information for an enterprise, the information including:
product inventory information for a plurality of differing products at each of a plurality of enterprise nodes;
delivery-chain specifications regarding a plurality of different order-fulfillment delivery chains;
automatically aggregating like products for product orders entered by a plurality of different customers as a function of the product inventory information and the delivery-chain specifications to reduce delivery costs.

10. The method of claim 9 wherein the plurality of enterprise nodes includes at least one distribution center and at least one retail facility.

11. The method of claim 10 wherein the plurality of enterprise nodes includes a plurality of geographically distributed distribution centers and a plurality of geographically distributed retail facilities.

12. The method of claim 11 wherein the plurality of different order-fulfillment delivery chains includes order-fulfillment delivery chains that provide for delivering an ordered product to a customer's address as well as order-fulfillment delivery chains that provide for delivering and ordered product to an enterprise retail facility for in-store pickup by a customer.

13. The method of claim 11 wherein the plurality of different order-fulfillment delivery chains includes order-fulfillment delivery chains that rely at least in substantial part upon a use of enterprise-controlled vehicles.

14. The method of claim 13 wherein the plurality of different order-fulfillment delivery chains further includes order-fulfillment delivery chains that rely at least in substantial part upon use of third-party-controlled vehicles.

15. The method of claim 9 wherein automatically aggregating like products for product orders entered by a plurality of different customers as a function of the product inventory information and the delivery-chain specifications comprises, at least in part, automatically considering opportunities to cartonize a plurality of like products as ordered by different customers.

16. The method of claim 9 wherein automatically aggregating like products for product orders entered by a plurality of different customers as a function of the product inventory information and the delivery-chain specifications comprises, at least in part, taking into account delivery due dates as correspond to at least some of the product orders.

17. A non-transitory memory having computer instructions stored therein, which computer instructions when executed by a control circuit cause the control circuit to:
access information for an enterprise, the information including:
product inventory information for a plurality of differing products at each of a plurality of enterprise nodes;
delivery-chain specifications regarding a plurality of different order-fulfillment delivery chains;
automatically aggregate like products for product orders entered by a plurality of different customers as a function of the product inventory information and the delivery-chain specifications to reduce delivery costs.

18. The non-transitory memory of claim 17 wherein the plurality of enterprise nodes includes a plurality of geographically distributed distribution centers and a plurality of geographically distributed retail facilities.

19. The non-transitory memory of claim 17 wherein automatically aggregating like products for product orders entered by a plurality of different customers as a function of the product inventory information and the delivery-chain specifications comprises, at least in part, automatically considering opportunities to cartonize a plurality of like products as ordered by different customers.

20. The non-transitory memory of claim 17 wherein automatically aggregating like products for product orders entered by a plurality of different on-line customers as a function of the product inventory information and the delivery-chain specifications comprises, at least in part, taking into account delivery due dates as correspond to at least some of the product orders.
